(19) United States
(12) Patent Application Publication
(10) Pub. No.: US 2007/0055898 A1
(43) Pub. Date: Mar. 8, 2007

(54) Control of signal line voltages on a bus

(76) Inventor: Ban Hok Goh, Singapore (SG)

Correspondence Address: SLATER & MATSIL LLP, 17950 PRESTON ROAD, SUITE 1000, DALLAS, TX, 75252, US

(21) Appl. No.: 11/220,365

(22) Filed: Sep. 6, 2005

(51) Int. Cl. G06F 1/26

(52) U.S. Cl. 713/300

(57) ABSTRACT

An apparatus is provided comprising a control chip, at least one peripheral chip connected to the control chip via a bus, the bus comprising a plurality of signal lines, and a control circuit coupled to each signal line of the bus. Each control circuit comprises a comparator for comparing voltage on the signal line with a reference voltage, and a driver connected to the comparator, for supplying power to the signal line, the driver being arranged to increase power supplied to the signal line if the voltage on the signal line is less than the reference voltage, the greater the difference between the voltage on the signal line and the reference voltage, the greater the increase in power supplied to the signal line, and to decrease power supplied to the signal line if the voltage on the signal line is greater than the reference voltage, the greater the difference between the voltage on the signal line and the reference voltage, the greater the decrease in power supplied to the signal line. There is also provided a method for monitoring each signal line of a bus connecting a control chip with at least one peripheral chip.

### TECHNICAL FIELD

The invention relates to an apparatus and method for controlling power supplied to each signal line on a bus. In particular, the invention relates to an apparatus and method for controlling power supplied to each signal line on a bus, in which the bus connects a control chip to a plurality of peripheral chips and each peripheral chip requires a different number of the bus signal lines for operation.

### BACKGROUND

Today, many communication products are System-on-Chip (SoC) products. SoC arrangements are ones in which the chip holds all the necessary hardware and electronic circuitry for a complete memory. In some arrangements, the SoC includes on-chip memory (RAM (Random Access Memory) and/or ROM (Read Only Memory)), a microprocessor, peripheral interfaces, I/O (input/output) logic control, data converters and other components required for the system. In other arrangements, the SoC has an embedded processor and an SDRAM (Synchronous Dynamic RAM) controller to control external SDRAM chips, flash memory chips, RTC (real time clock) chips and any other peripheral chips.

In arrangements where the SoC includes a processor and an SDRAM controller for controlling peripheral chips, typically the peripheral chips share a single bus. However, not all the peripheral chips will require use of all the data and address lines on the bus. For example, the SDRAM controller on the SoC could support 32 bit data lines (termed D0 to D31) and 20 bit address lines (termed A0 to A19), but a device such as the RTC chip might only require 8 of the data lines (e.g. D0 to D7) and 10 of the address lines (e.g. A0 to A9). So, some of the signal lines on the bus will be more heavily loaded than others and this will cause an unbalance in the loading between the pins.

An example of one such arrangement is shown in FIG. 1. In FIG. 1, the SoC 101 (which includes an SDRAM controller (not shown)) is connected to two SDRAM chips 103, 105, two flash memory chips 107, 109 and one RTC chip 111 via a bus 113 having 32 data lines (D0 to D31) and 20 address lines (A0 to A19). The SDRAM chips each require 16 data lines (D0 to D15 for chip 103 and D16 to D31 for chip 105) and 13 address lines (A0 to A12 for both chips 103 and 105). The flash memory chips each require 16 data lines (D0 to D15 for chip 107 and D16 to D31 for chip 109) and 20 address lines (A0 to A19 for both chips 107 and 109). The RTC chip requires only 8 data lines (D0 to D7) and 11 address lines (A0 to A10). Thus, in the arrangement of FIG. 1, the data lines D0 to D7 will be more heavily loaded than the other data lines and the address lines A0 to A10 will be more heavily loaded than the other address lines. Because of the heavier load, D0 to D7 and A0 to A10 will show a voltage dip compared with other data and address lines that are not so heavily loaded. This is shown schematically in FIG. 2. FIG. 2a shows a voltage versus time plot for data line D0 and FIG. 2b shows a voltage versus time plot for data line D15. Because D0 is more heavily loaded than D15, the plot of FIG. 2a shows a voltage dip.

This voltage dip is a problem that can cause bit error and system failure on a PCB board and the problem is, of course, exacerbated with higher temperature. The voltage dip problem is one that may arise not just in SoC SDRAM systems like that described above, but any system in which a control chip is connected to a number of peripheral chips and the peripheral chips do not all require the same number of bus signal lines for their operation, i.e., any system in which some imbalance between pins can be expected.

Note that, in the arrangement in FIG. 1, the number of data lines on the bus is 32 and the number of address lines is 20, but it should be appreciated that there may be any number of data lines and address lines on the bus and the voltage dip problem may still be noticed. In addition, in FIG. 1, only SDRAM, flash memory and RTC chips are shown, but it should be appreciated that other peripheral chips might also be connected to the bus.

To date, the problem of unbalanced loading and the resulting voltage dip has been solved by providing extra address and data buffer chips in order to separate the flash memory and RTC chips from the SDRAM chips. However, PCB board trace variations may still be observed with this arrangement and very stringent PCB design rules have to be observed to reduce the data error.

### SUMMARY OF THE INVENTION

In one aspect, the invention provides an apparatus and method that mitigates or substantially overcomes problems of the known arrangements described above.

According to a first aspect of the invention, there is provided an apparatus that includes a control chip and at least one peripheral chip coupled to the control chip via a bus, the bus including a plurality of signal lines. A control circuit is coupled to each signal line of the bus. Each control circuit includes a comparator for comparing voltage on the signal line with a reference voltage. A driver is coupled to the comparator for supplying power to the signal line. The driver is arranged to increase power supplied to the signal line if the voltage on the signal line is less than the reference voltage. The greater the difference between the voltage on the signal line and the reference voltage, the greater the increase in power supplied to the signal line. The driver is also arranged to decrease power supplied to the signal line if the voltage on the signal line is greater than the reference voltage. The greater the difference between the voltage on the signal line and the reference voltage, the greater the decrease in power supplied to the signal line.

In this apparatus, not all the peripheral chips will require use of all the signal lines on the bus so some signal lines will be more heavily loaded than others. The control circuit is able to determine whether the voltage on the signal line is small, due to a heavy load on the signal line, or large, due to a lighter load on the signal line, by comparing the voltage with the reference voltage. The reference voltage is preferably set at a voltage such that, when the signal line is heavily loaded, the voltage on the signal line is less than the reference voltage and, when the signal line is not so heavily loaded, the voltage on the signal line is greater than the reference voltage. That is, the reference voltage is set to some optimal value that is high enough for data qualification. Then, the power supplied to the signal line by the driver can be increased for a low voltage (heavy load, voltage difference in one direction) so as to avoid a voltage dip on that signal line, and decreased for a higher voltage (lighter load, voltage difference in the other direction). The reference voltage is set at some average level and the driver works to set every line to that reference voltage, by increasing or decreasing the power. In this way, the various signal lines can be balanced, which will avoid a voltage dip on heavily loaded signal lines.

Note that a control circuit is required for each signal line so that all the signal lines can be balanced.

The reference voltage may be set by a user. The reference voltage is preferably set to be the same for each signal line of the bus.

The control chip may be a System-on-Chip. Alternatively, the control chip could be any chip that can partially or fully control one or more of the peripheral chips.

The control chip may include an SDRAM controller. In that case, the at least one peripheral chip may comprise at least one SDRAM chip. Alternatively, the control chip may include a flash controller, in which case, the at least one peripheral chip may comprise at least one flash chip.

The at least one peripheral chip may comprise at least one flash memory chip. The at least one peripheral chip may comprise at least one clock chip. The at least one peripheral chip may comprise any of an RTC (real time clock) chip, an FPGA (field programmable gate array) chip, a CPLD (computer programmable logic device) chip, a temperature sensor chip, a multiplexor, a demultiplexor, a decoder, an encoder and a counter.

The plurality of signal lines may include a plurality of data lines. The plurality of signal lines may include a plurality of address lines.

In one embodiment, the comparator comprises a differential amplifier. In that embodiment, the output of the differential amplifier may be input into the driver so that the power supplied by the driver depends on the differential amplifier output, i.e., the difference between the voltage on the signal line and the reference voltage.

The driver may receive a gating signal input, which may be a WRITE signal. This signal is used to select the write path, if necessary.

According to a second aspect of the invention, there is provided an apparatus for connecting to each signal line of a bus a control chip with at least one peripheral chip. The apparatus includes a comparator for comparing voltage on the signal line with a reference voltage, and a driver connected to the comparator, for supplying power to the signal line. The driver is arranged to increase power supplied to the signal line if the voltage on the signal line is less than the reference voltage. The greater the difference between the voltage on the signal line and the reference voltage, the greater the increase in power supplied to the signal line. The driver is also arranged to decrease power supplied to the signal line if the voltage on the signal line is greater than the reference voltage. The greater the difference between the voltage on the signal line and the reference voltage, the greater the decrease in power supplied to the signal line.

The apparatus is able to determine whether the voltage on the signal line is small, due to a heavy load on the signal line, or large, due to a lighter load on the signal line, by comparing the voltage on the signal line with the reference voltage. Then, the power supplied to the signal line by the driver can be increased for a low voltage (heavy load) and decreased for a higher voltage (lighter load). In this way, the various signal lines on the bus can be balanced, which will avoid a voltage dip on heavily loaded signal lines.

The plurality of signal lines may include a plurality of data lines. The plurality of signal lines may include a plurality of address lines.

In one embodiment, the comparator comprises a differential amplifier. In that embodiment, the output of the differential amplifier may be connected to an input of the driver. In that case, the power supplied by the driver depends on the differential amplifier output, i.e., the difference between the voltage on the signal line and the reference voltage.

The driver may receive a gating signal input, which may be a WRITE signal.

According to the second aspect of the invention, there is also provided an apparatus for connecting to each signal line of a bus a control chip with at least one peripheral chip. The apparatus includes a comparator for comparing voltage on the signal line with a reference voltage, and a driver connected to the comparator for supplying power to the signal line. The driver is arranged to provide a change to the power supplied to the signal line, depending upon the output of the comparator, so as to attempt to match the voltage on the signal line to the reference voltage.

According to a third aspect of the invention, there is provided a method for monitoring each signal line of a bus connecting a control chip with at least one peripheral chip. The method includes comparing the voltage on the signal line with a reference voltage, and, in response to the comparison, controlling power supplied to the signal line such that, if the voltage on the signal line is less than the reference voltage, the power supplied to the signal line is increased. The greater the difference between the voltage on the signal line and the reference voltage, the greater the increase in power supplied to the signal line. If the voltage on the signal line is greater than the reference voltage, the power supplied to the signal line is decreased. The greater the difference between the voltage on the signal line and the reference voltage, the greater the decrease in power supplied to the signal line.

This method monitors whether the voltage on the signal line is small, due to a heavy load on the signal line, or large, due to a lighter load on the signal line, by comparing the voltage with the reference voltage. Then, the power supplied to the signal line by the driver can be increased for a low voltage (heavy load, positive voltage difference) so as to avoid a voltage dip on that signal line, and decreased for a higher voltage (lighter load, negative voltage difference). In this way, the various signal lines can be balanced, which will avoid a voltage dip on heavily loaded signal lines.

The plurality of signal lines may include a plurality of data lines. The plurality of signal lines may include a plurality of address lines.

Features described in relation to one aspect of the invention may also be applicable to other aspects of the invention.

### DESCRIPTION OF THE DRAWINGS

Known arrangements have already been described with reference to FIGS. 1, 2a and 2b of the accompanying drawings, of which:

FIG. 1 is a diagram of one example of an SoC arrangement experiencing unbalanced loading between pins;

FIG. 2a is a voltage-time plot of data line D0 of FIG. 1;

FIG. 2b is a voltage-time plot of data line D15 of FIG. 1; and

FIG. 3 shows circuitry that can be used to monitor each data line and address line.

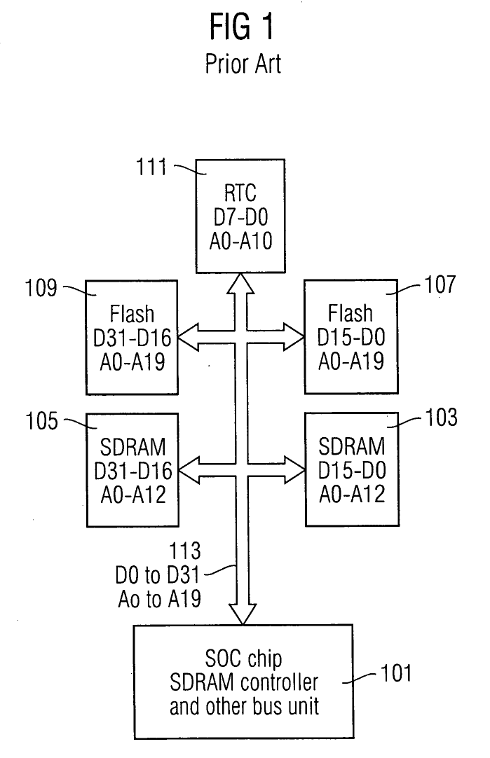

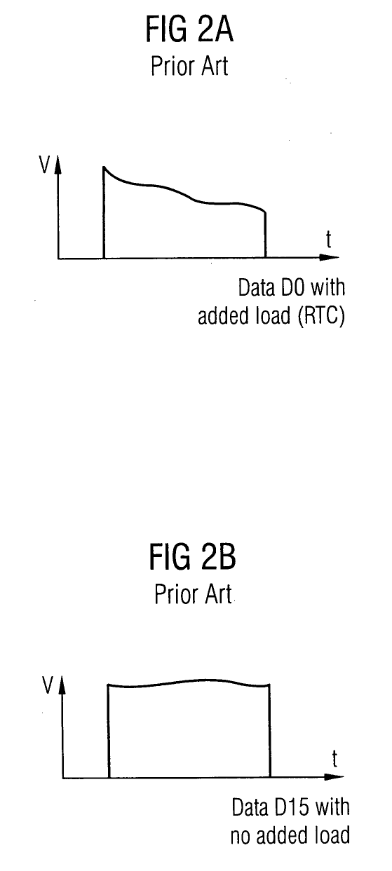

### DETAILED DESCRIPTION OF ILLUSTRATIVE EMBODIMENTS

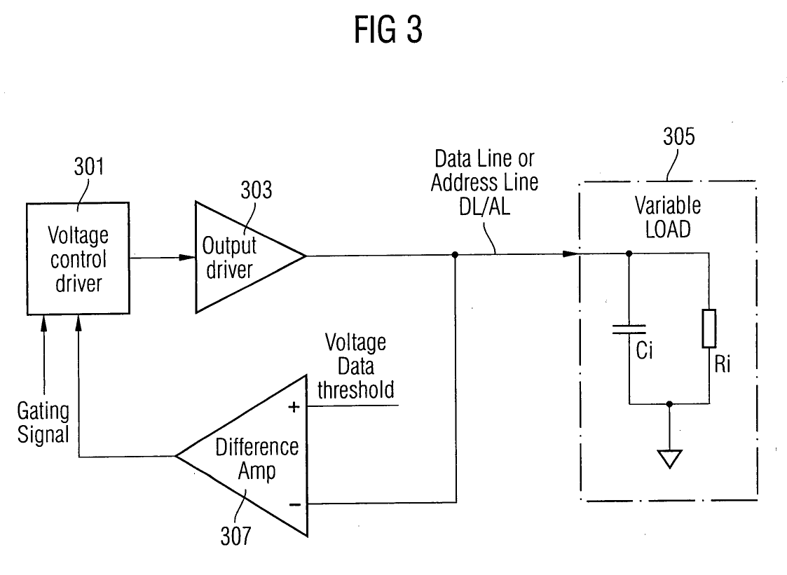

An exemplary embodiment of the invention will now be described with reference to FIG. 3 of the accompanying drawings, which is a diagram showing circuitry which can be used to monitor each data line and address line.

The circuitry includes a voltage control driver 301 connected to an output driver 303. The output driver 303 is connected to the particular data or address line to be monitored (termed DL/AL) and that data or address line is connected to a load 305. The load is a variable load since it depends on the number of peripheral chips sharing that data or address line. The voltage from the output driver 303 is compared with a threshold voltage in a differential amplifier 307. The output from the differential amplifier is input back into the voltage control driver 301. The voltage control driver 301 also receives a gating signal such as a write (WR) signal.

The circuitry can be used on each data and address line on the bus between an SoC (or other control chip) and peripheral chips. That is, the voltage will be monitored on all data lines, e.g., D0 to D31 and all address lines, e.g., A0 to A19. The load will differ from one line to the next because there may be a different number of peripheral chips making use of that data or address line.

Referring again to FIG. 3, the voltage on DL/AL is fed into the differential amplifier 307. The differential amplifier compares the voltage on the DL/AL with a reference voltage. This reference voltage could be programmable so as to allow a user to enter an expected threshold voltage. The differential amplifier outputs the difference to the voltage control driver 301.

If the data or address line is connected to a heavy load 305 (because many peripheral chips are making use of that data or address line), the voltage on the DL/AL will be low. Thus, the reference voltage will be larger than the DL/AL voltage and the difference between the DL/AL voltage and the reference voltage will be positive, i.e., the DL/AL voltage will be less therefore, provide more power to drive the heavier load. This means that the higher power allows for the higher load so as to avoid a voltage dip on that line.

On the other hand, if the data or address line is connected to a relatively light load (because not many data or address lines are making use of that data or address lines), the DL/AL voltage will be higher. Thus, the reference voltage will be smaller than the DL/AL voltage and the difference between the DL/AL voltage and the reference voltage will be negative, i.e., the DL/AL voltage will be greater than the reference voltage. This difference will be input to the voltage control driver, which will consequently provide less power to drive the lighter load.

In the arrangement of FIG. 3, the differential amplifier is arranged such that, if the reference voltage is greater than the DL/AL voltage, this constitutes a positive difference and results in a positive change (i.e., increase) in the power supplied to the line. Similarly, in FIG. 3, if the reference voltage is less than the DL/AL voltage, this constitutes a negative difference and results in a negative change (i.e., decrease) in the power supplied to the line. However, the differential amplifier could alternatively be arranged such that a positive difference between the reference voltage and the DL/AL voltage results in a decrease in power supplied and a negative difference between the reference voltage and the DL/AL voltage results in a decrease in power supplied. This could be achieved by swapping the two inputs to the differential amplifier.

Thus, all the data and address lines of the bus are monitored and it is possible to determine the loading of each pin by measuring the voltage. It is then possible to create a balance between loads across all the data and address lines of the bus.

In this way, by monitoring the voltage on each data and address line and providing power appropriately, the load on each pin can be balanced. This avoids the problems that may arise due to unbalanced loading between the pins. The arrangement described avoids the use of buffer chips and reduces PCB design effort. It eliminates PCB board trace variations whilst allowing reduced chip size.

What is claimed is:

1. An apparatus comprising:
a control chip;
at least one peripheral chip coupled to the control chip via a bus, the bus comprising a plurality of signal lines; and
a plurality of control circuits, each control circuit coupled to a respective one of the signal lines of the bus, each control circuit comprising:
a comparator for comparing voltage on the signal line with a reference voltage; and
a driver coupled to the comparator for supplying power to the signal line, the driver being arranged to increase power supplied to the signal line if the voltage on the signal line is less than the reference voltage, the greater the difference between the voltage on the signal line and the reference voltage, the greater the increase in power supplied to the signal line, and to decrease power supplied to the signal line if the voltage on the signal line is greater than the reference voltage, the greater the difference between the voltage on the signal line and the reference voltage, the greater the decrease in power supplied to the signal line.

2. The apparatus of claim 1, wherein the control chip is a System-on-Chip.

3. The apparatus of claim 1, wherein the control chip includes an SDRAM controller.

4. The apparatus of claim 3, wherein the at least one peripheral chip comprises at least one SDRAM chip.

5. The apparatus of claim 1, wherein the at least one peripheral chip comprises at least one flash memory chip.

6. The apparatus of claim 1, wherein the at least one peripheral chip comprises at least one clock chip.

7. The apparatus of claim 1, wherein the plurality of signal lines includes a plurality of data lines.

8. The apparatus of claim 1, wherein the plurality of signal lines includes a plurality of address lines.

9. The apparatus of claim 1, wherein the comparator comprises a differential amplifier.

10. The apparatus of claim 1, wherein the driver receives a gating signal input.

11. An apparatus to be coupled to each signal line of a bus coupled between a control chip and at least one peripheral chip, the apparatus comprising:
a comparator for comparing voltage on the signal line with a reference voltage; and
a driver coupled to the comparator, for supplying power to the signal line, the driver being arranged to increase power supplied to the signal line if the voltage on the signal line is less than the reference voltage, the greater the difference between the voltage on the signal line and the reference voltage, the greater the increase in power supplied to the signal line, and to decrease power supplied to the signal line if the voltage on the signal line is greater than the reference voltage, the greater the difference between the voltage on the signal line and the reference voltage, the greater the decrease in power supplied to the signal line.

12. The apparatus of claim 11, wherein the plurality of signal lines includes a plurality of data lines.

13. The apparatus of claim 11, wherein the plurality of signal lines includes a plurality of address lines.

14. The apparatus of claim 11, wherein the comparator comprises a differential amplifier.

15. The apparatus of claim 14, wherein an output of the differential amplifier is coupled to an input of the driver.

16. The apparatus of claim 11, wherein the driver receives a gating signal input.

17. An apparatus to be coupled to each signal line of a bus coupled between a control chip and at least one peripheral chip, the apparatus comprising:
a comparator for comparing voltage on the signal line with a reference voltage; and
a driver coupled to the comparator, the driver supplying power to the signal line, the driver being arranged to provide a change to the power supplied to the signal line, depending upon the output of the comparator, so as to attempt to match the voltage on the signal line to the reference voltage.

18. A method for monitoring each signal line of a bus coupled between a control chip and at least one peripheral chip, the method comprising:
comparing voltage on the signal line with a reference voltage; and
in response to the comparison, controlling power supplied to the signal line such that, if the voltage on the signal line is less than the reference voltage, the power supplied to the signal line is increased, the greater the difference between the voltage on the signal line and the reference voltage, the greater the increase in power supplied to the signal line, and, if the voltage on the signal line is greater than the reference voltage, the power supplied to the signal line is decreased, the greater the difference between the voltage on the signal line and the reference voltage, the greater the decrease in power supplied to the signal line.

19. The method of claim 18 wherein the plurality of signal lines includes a plurality of data lines.

20. The method of claim 18, wherein the plurality of signal lines includes a plurality of address lines.
